(19) United States
(12) Patent Application Publication
(10) Pub. No.: US 2014/0164556 A1
(43) Pub. Date: Jun. 12, 2014

(54) METHOD AND SYSTEM FOR LIVE LOADING OF A TOOLBAR

(71) Applicant: DEALBASE, INC., Manhattan Beach, CA (US)

(72) Inventor: Cory O'Daniel, Culver City, CA (US)

(73) Assignee: Dealbase, Inc., Manhattan Beach, CA (US)

(21) Appl. No.: 13/711,468

(22) Filed: Dec. 11, 2012

(51) Int. Cl. H04L 29/08

(52) U.S. Cl. CPC H04L 67/10
USPC 709/217

(57) ABSTRACT

System and method of live loading of a toolbar script facilitates loading of a current version of the toolbar script every time a page is loaded on a browser. In one embodiment, for each browser session, a toolbar component establishes a connection to the remote server, and downloads the current version of the toolbar script in plain text format. A toolbar component loads the plain text toolbar script into a memory location instantiated by the browser. At run time, a toolbar component evaluates the plain text toolbar script as code to handle various events and perform the functionalities defined in the toolbar script.

### BACKGROUND

Most browsers allow and support installation of toolbars, extensions, plug-ins, Browser Helper Objects (BHOs) and add-ons (hereinafter “toolbars”). Toolbars allow customization of browsers and provide additional functionality. Toolbars are downloaded and installed to run off of the local disk.

A toolbar provider may release a new version of a toolbar to add new features, fix bugs or compatibility issues, etc. When a new version of a toolbar is released, some browsers can automatically download the toolbar in the background, and ask the user to confirm installation of the new version. When the browser is restarted, the new version of the toolbar is loaded. Other browsers may require the user to manually download and install the new version. As not all users download and install the new version of the toolbar, the toolbar provider needs to manage and support multiple versions of the toolbar at any given time.

### BRIEF DESCRIPTION OF THE DRAWINGS

FIG. 1 illustrates an example diagram of a system having a toolbar server accessible by a plurality of client devices for live loading of a toolbar.

FIG. 2A depicts a block diagram illustrating an example of components in a client device for live loading of a toolbar.

FIG. 2B depicts a block diagram illustrating an example of components in a toolbar server for live loading of a toolbar.

FIG. 3 illustrates a logic flow diagram of an example method for live loading of a toolbar.

FIG. 4 shows a diagrammatic representation of a machine in the example form of a computer system within which a set of instructions, for causing the machine to perform any one or more of the methodologies discussed herein, may be executed.

### DETAILED DESCRIPTION

References in this description to “an embodiment,” “one embodiment,” or the like, mean that the particular feature, function, or characteristic being described is included in at least one embodiment of the present invention. Occurrences of such phrases in this specification do not necessarily all refer to the same embodiment, nor are they necessarily mutually exclusive.

Embodiments of the present disclosure include method and system of live loading of a toolbar. The embodiments facilitate loading of a current version of a toolbar every time a web page is loaded on a browser. A toolbar may include a collection of files such as, but not limited to: a configuration or manifest file, scripts or script files, images, style, layout, and/or the like. Although the description herein refers to toolbar scripts in particular, it should be understood that the method and system described herein are applicable to all files that usually reside in a toolbar package.

In one embodiment, a toolbar component in a client device accesses a network to connect to a remote server and download from the remote server a current version of the toolbar script. In another embodiment, a toolbar component first determines whether a version of the toolbar script at the remote server is the same version as that in the client device. If so, the toolbar component does not initiate a download of the toolbar script from the remote server. Conversely, if the versions are different, the toolbar component establishes a connection to the remote server, and downloads the current version of the toolbar script in plain text format.

In a further embodiment, a toolbar component loads the plain text toolbar script into a memory location instantiated by the browser. At run time, a toolbar component evaluates the plain text toolbar script as code to handle various events and perform the functionalities defined in the toolbar script.

Live loading of the toolbar script provides several advantages. For example, live loading of the toolbar script ensures that an update on the toolbar script is immediately distributed and effected when a browser is launched in a client device connected to a network. Live loading of the toolbar script also reduces the burden on the toolbar providers or vendors that manage and support toolbars. For example, instead of having to support toolbar script versions 1, 2 and 3 that may be running on various client devices, live loading of a toolbar script ensures that only version 3 is running. Thus the toolbar provider or vendor needs to support only version 3 of the toolbar script.

The embodiments of the system and method of live loading of a toolbar will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

### Exemplary Environment

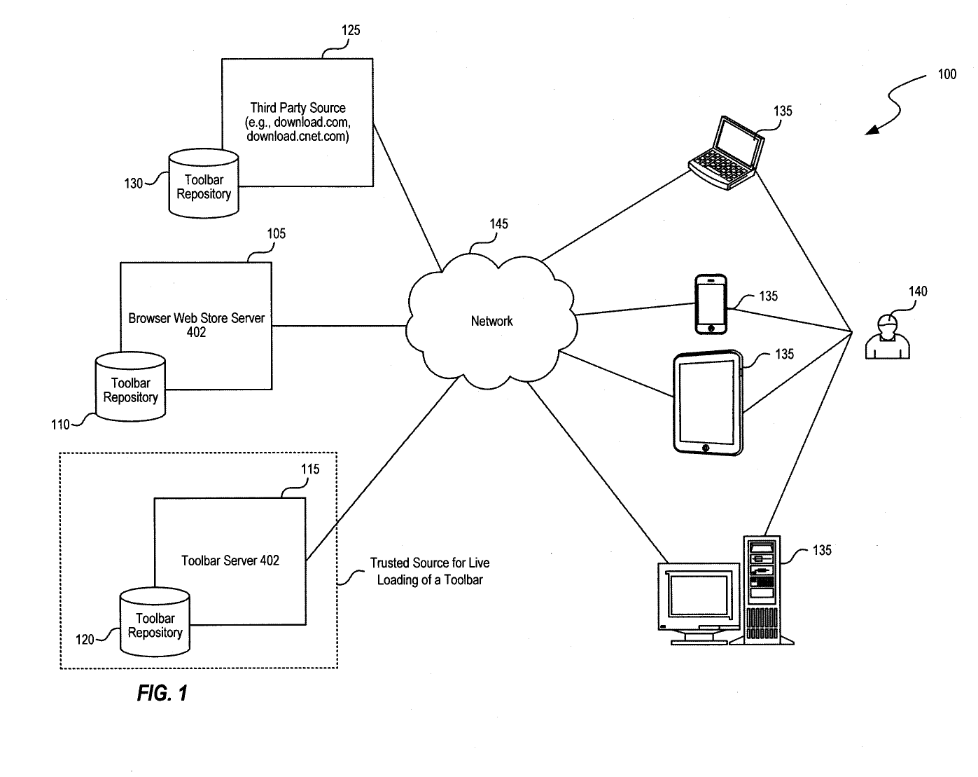

FIG. 1 illustrates an example diagram of a system having a toolbar server accessible by a plurality of client devices for live loading of a toolbar script.

Environment 100 may include a plurality of client devices 135, a browser web store server 105, a toolbar server 115 and a third party source 125. Client devices 135 can be any system, device, or a combination thereof that can establish a connection, including wired, wireless and/or cellular connections with another system, device and/or server such as the browser web store server 105, the toolbar server 115 and the third party server 125. Client devices 135 use browsers to retrieve, present and traverse resources on the Internet or on other private networks and file systems. Some client devices such as laptops and computers use web browsers, while other client devices such smart phones, tablets and other mobile devices use mobile browsers. Examples of web browsers include the Internet Explorer, Firefox, Chrome, Safari, Opera, and the like. Examples of mobile browsers include the Android browser, Blackberry browser, Firefox for mobile, Internet Explorer for mobile, Safari, Skyfire, and the like. Client devices 135 typically include a display and/or other output functionalities to present the information retrieved or accessed from remote systems such as the browser web store server 105, the toolbar server 115 and the third party source 125.

In some embodiments, any one of the servers 105, 115 and 125 may be operational. In other embodiments, additional servers such as an intermediary or proxy server may be operational. Client devices communicate with remote servers such as the browser web store server 105, the toolbar server 115 or the third party source 125 over network 145. In general, network 145 may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and the like); and the like.

The browser web store server 105 may host an online store for web applications including browsers and toolbars. User 140 can visit the online store to download a desired toolbar and install the toolbar for the first time to his or her client device 135. The toolbar files may be stored in a repository 110 maintained by the browser web store server 105. Although only one browser web store server 105 is illustrated, it should be understood that more than one browser web store server may be a part of the environment 100.

The toolbar server 115 can allow download of a toolbar to client devices 135 via the network 145. The toolbar server 115 may be implemented and/or operated by the toolbar provider or vendor. A user 140 can visit an online store hosted by the toolbar server 115 to download a toolbar for the first time to his or her client device. In some embodiments, the browser web store server 105 may be in direct communication with the toolbar server 115 and/or its toolbar repository 120 to facilitate downloading of the toolbar. Other third party sources 125 may also be included in the environment 100. A third party source can maintain a repository 130 of toolbars from various providers or vendors. An example of a third party source includes sites such as cnet.download.com, download.com, etc.

The initial download and installation of a toolbar can be from any number of sources discussed above. In some cases, a toolbar may be bundled with other applications. A user provides explicit confirmation and/or permission to download and install the toolbar on a browser. However, subsequent live loading of the toolbar script that includes downloading current version of the toolbar script and loading of the downloaded toolbar script to an instance of the browser is automatically carried out, in the background, after the browser is instantiated. The current version of the toolbar script for live loading can be downloaded from one or more select sources that is trusted. In one implementation, for example, the trusted source for toolbar scripts for live loading may be the toolbar server 115. In another implementation, any server that uses encryption methods such as public/private key encryption to sign toolbar files may be allowed to act as the source for live loading toolbar scripts.

### Example System Components for Live Loading of a Toolbar Script

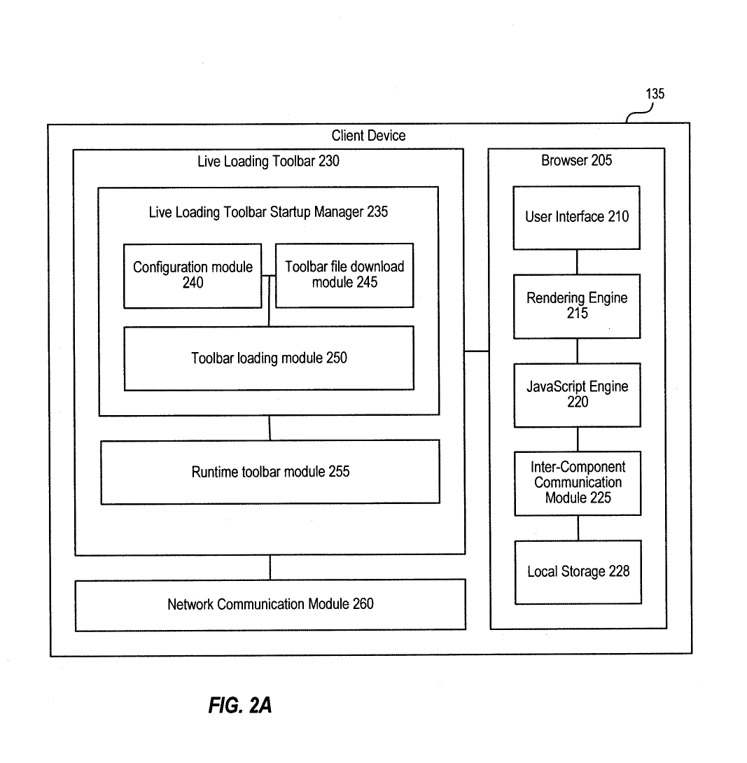

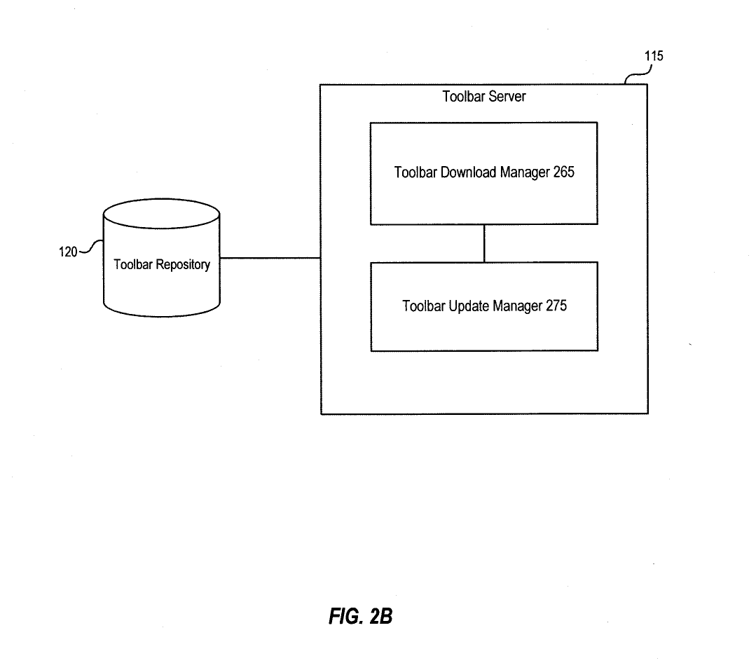

FIG. 2A shows a block diagram illustrating example components in a client device for live loading of a toolbar script. A client device 135 includes at least one browser 205, a live loading toolbar 230, and a network communication module 260, among others.

The main components of a browser 205 are the user interface 210, the rendering engine 215, the JavaScript engine 220, the inter-component communication module 225 and local storage 228. The user interface 210 includes the user interface elements such as an address bar, a button, a menu and the like that are a part of the browser display. The main window where the requested page is displayed is not considered to be a part of the user interface. The rendering engine 215 renders or displays the requested page. For example, if the requested page is HyperText Markup Language (HTML), the rendering engine 215 can parse the HTML and Cascading Style Sheets (CSS) in the requested page and display the parsed content on the screen. Examples of the rendering engine includes Gecko in Firefox and Webkit in Safari and Chrome. The JavaScript engine 220 is responsible for parsing and executing JavaScript code. Each browser usually has its own JavaScript engine to interpret and execute JavaScript codes which are extensively used in web pages, web applications and toolbars. The inter-component communication module 225 facilitates communication between browser components such as the user interface 210 and the rendering engine 215. The local storage 228 is a persistent data storage for storing browser session data such as cookies, bookmarks and cache on the local disk.

In one embodiment, the client device 135 may also include a toolbar manager (not shown) that can be a separate module, or a module that is a part of the browser 205. The toolbar manager or the browser 205 can start and stop the processes of the live loading toolbar 230.

The live loading toolbar 230 includes several modules. One or more of these modules may be consolidated into a single module. Live loading toolbar startup manager 235 process is initiated when a page is loaded on a browser. The startup manager 235 may include several modules that perform tasks resulting in live loading of the current version of the toolbar script.

The configuration module 240 includes configuration information for live loading of the toolbar script. For example, the configuration module may provide server location (e.g., Uniform Resource Locator (URL)), toolbar version installed on the browser, location where the toolbar script is to be downloaded, browser identifier, version identifier, toolbar identifier, and the like. The configuration module 240 may also include instructions for the browser for processing and/or managing the toolbar, identifying contents of the toolbar, and the like.

The toolbar script download module 245 is responsible for reading or obtaining information from the configuration module 240. The toolbar script download module 245 can generate and send a request based on Hypertext Transfer Protocol (HTTP), Hypertext Transfer Protocol Secure (HTTPS) or any other suitable communication protocol over a network 145 to the trusted source such as the toolbar server 115 to obtain a current version of the toolbar script for live loading. The HTTP/HTTPS request to the toolbar server 115 and response from the toolbar server is handled at the client side by the network communication module 260 that supports various connection protocols such as, but not limited to: direct connect; Ethernet; wireless connection such as IEEE 802.11a-x; and the like. In one implementation, the toolbar script download module 245 may use a JavaScript Application Programming Interface (API) such as XMLHttpRequest (XHR) to send the HTTP/HTTPS request to the toolbar server 115 and process the response from the toolbar server 115. The response from the toolbar server 115 includes a toolbar script that is in a non-executable format such as, but not limited to: plain text, XML, JSON, and the like. Since the operating system typically requires user confirmation to download and install an executable file, downloading the toolbar script in a non-executable format allows live loading of the toolbar script without incurring any restrictions from the operating system.

The toolbar loading module 250 is responsible for loading the current version of the toolbar script in plain text (or in other non-executable format) received from the toolbar server 115. The plain text toolbar script is loaded into memory instantiated by the browser. The toolbar loading module 250 may also load into memory other files such as the style, layout, images, and so on that are part of the toolbar package.

The runtime toolbar module 255 is responsible for evaluating the plain text toolbar script as code. The evaluation can be performed using an eval( ) function that directly executes the plain text toolbar script. Alternately, the plain text toolbar script may be evaluated in a sandbox with limited privileges.

The live loading toolbar 230 may also include an optional toolbar installer that installs a toolbar for the first time by extracting or copying the toolbar package or bundle (e.g., toolbar.xpi) to a specific directory. Generally, the operating system can handle installation of a toolbar.

In one embodiment, the live loading toolbar 230 may also include a verification module (not shown) for verifying the authenticity of the toolbar script and any other files downloaded from the toolbar server. For example, in one implementation, a public/private key encryption may be used. The toolbar script and any other files encrypted by the toolbar server with a private key may be verified by decrypting the encrypted files with a public key that is also provided by the toolbar server.

FIG. 2B depicts a block diagram illustrating example components in the toolbar server 115 for live loading of a toolbar script. The toolbar server 115 may include components such as a toolbar download manager 265 and a toolbar update manager 275, among others.

The toolbar download manager 265 is responsible for handling requests for a current version of a toolbar script. For example, when a request from a client device for a current version of the toolbar script is received, the toolbar download manager 265 parses the request, creates a query (e.g., in SQL) and executes the query on the toolbar repository 120 to retrieve the current version of the toolbar script. The toolbar download manager 265 then sends a response including the current version of the toolbar script back to the client device 135. In one implementation, the toolbar download manager 265 may also send to the client device 135, any new versions of other toolbar files such as the manifest file, style files, images, and the like.

In one embodiment, the toolbar server may also include a toolbar update manager 275. The toolbar update manager 275 may be responsible for identifying the toolbar scripts and any other files that the toolbar download manager 265 can provide in response to the client request. For example, an incoming request for a current version of the toolbar script may be from a client device that has been offline for some time. Based on information on the version of the toolbar script on the client device, the toolbar update manager 275 can determine or identify the toolbar scripts and any other files that the client device would need. For example, if the request is from a client device with toolbar version number 2, and the current version available on the server is version number 6, the toolbar update manager 275 may determine, based on one or more rules, if version number 6 alone can be sent for live loading, or if version number 6 should be sent along with other intermediate versions (e.g., version number 3 and 4) to update the toolbar to the current version.

In one embodiment, the toolbar server may also include a signing module (not shown). The signing module may use public/private key encryption, for example, to encrypt any toolbar script and/or other files using a private key prior to sending the files to the client device.

### Example Method for Live Loading of a Toolbar Script

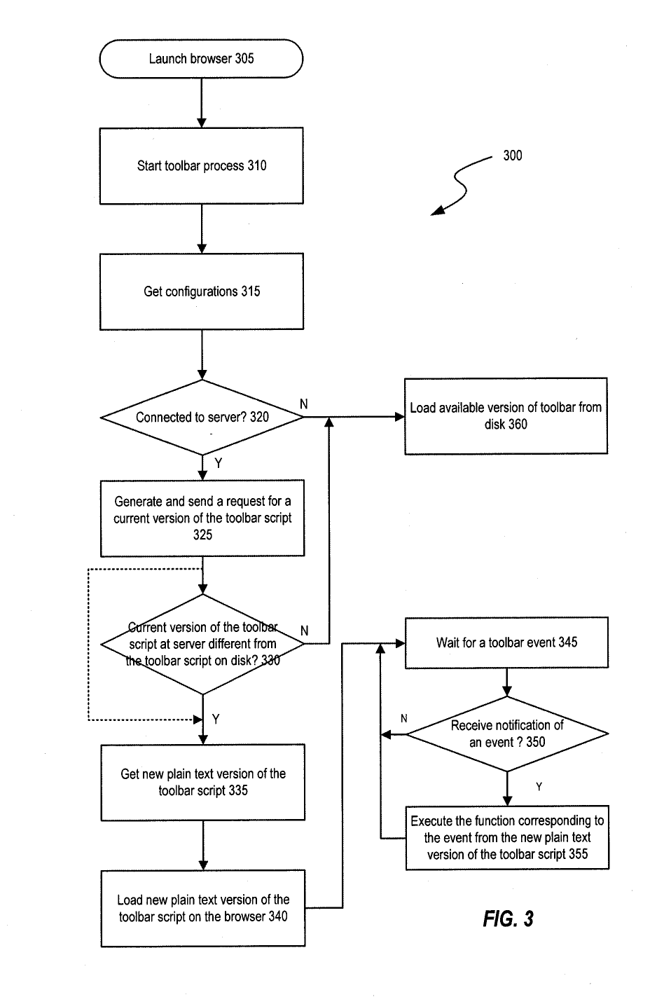

FIG. 3 illustrates a logic flow diagram of an example method for live loading of a toolbar script. The process of live loading of a toolbar is triggered when a browser in which the toolbar was previously installed is launched at block 305. At block 310, the toolbar process is started. In one implementation, the toolbar process may be performed by the live loading toolbar startup manager 235. At block 315, configuration information that is used to generate a request for a new version of the toolbar script can be obtained. As previously discussed, configuration information may include, but is not limited to: server location (e.g., Uniform Resource Locator (URL)), toolbar version installed on the browser, location where the toolbar script is to be downloaded, browser identifier, version identifier, toolbar identifier, and the like.

In some situations, when the toolbar server is down, or the client device is connected to an internal or private network, the connection to the toolbar server cannot be established, and the live loading of the toolbar script may not be possible. At decision block 320, if a network connection to the toolbar server is determined to be unavailable, the previously installed version of the toolbar script is loaded from local disk at block 360.

Conversely, if a connection to the toolbar server is determined to be available at decision block 320, a request for a current version of the toolbar script may be generated and sent to the toolbar server over the network at block 325. As previously discussed, the request may be sent as an HTTP/HTTPS request. In one implementation, at decision block 330, when the current version of the toolbar script available from the toolbar server for live loading and the toolbar script on disk are the same, the toolbar script on disk may be loaded at block 360. Conversely, if the two toolbar scripts are different, the current version of the toolbar script from the toolbar server may be downloaded at block 335 in plain text format. In an alternate implementation, the decision block 330 may be considered optional, such that the current version of the toolbar script is downloaded as plain text at block 335, regardless of whether the downloaded toolbar script is the same version as the version of the toolbar script on local disk. In one implementation, along with the toolbar script, other files such as manifest, image, CSS, and the like may be downloaded from the toolbar server. At block 340, the downloaded plain text toolbar script and/or other toolbar files may be loaded into memory space instantiated by the browser, which causes the browser to display the toolbar user interface and activate the associated functionality. A browser restart is not necessary to load the toolbar and its functionalities.

Once loaded, at block 345, the toolbar waits for an event to occur. When a notification of an event is received at decision block 350, the function corresponding to the event is executed at block 355. In one implementation, the execution includes evaluation of the function corresponding to the event directly from the plain text toolbar script. Various methods may be used for evaluating functions directly from the plain text toolbar script. For example, an eval( ) function, within or outside of a sandbox, may be used to execute the plain text toolbar script that is written in JavaScript.

### Example Apparatus

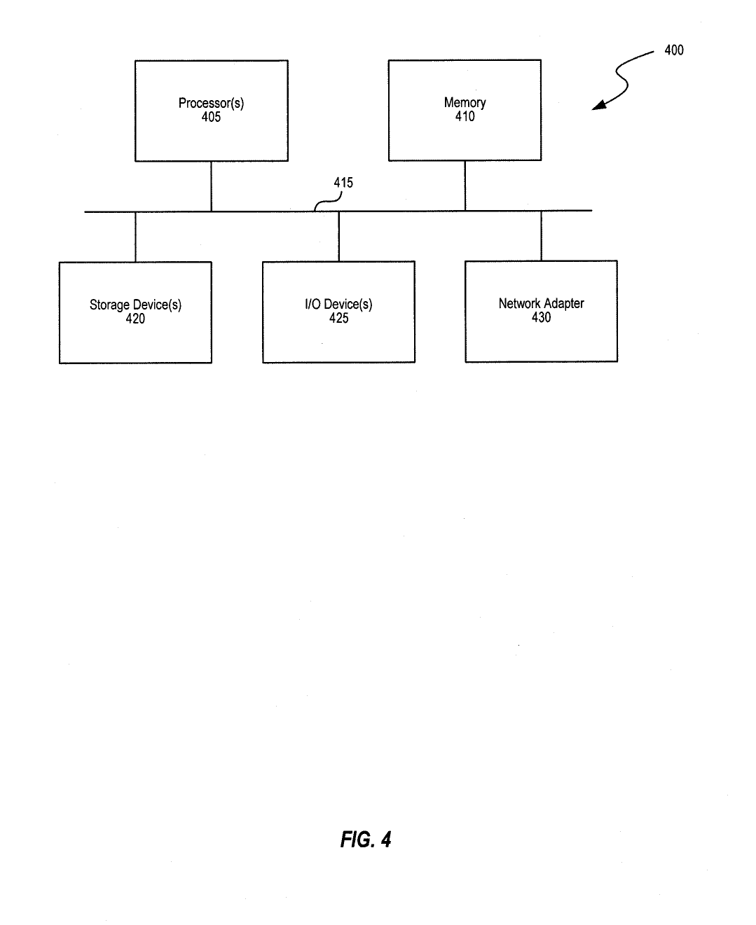

FIG. 4 is a block diagram of an exemplary apparatus that may perform various operations, and store various information generated and/or used by such operations, according to an embodiment of the disclosed technique. The apparatus can represent any computer described herein. The computer 400 is intended to illustrate a hardware device on which any of the entities, components or services depicted in the examples of FIGS. 1-3 (and any other components described in this specification) can be implemented, such as a server, client, storage devices, data repositories or databases, live loading toolbar 230 modules and sub-modules, browser 205 and browser components, and the like. The computer 400 includes one or more processors 405 and memory 410 coupled to an interconnect 415. The interconnect 415 is shown in FIG. 4 as an abstraction that represents any one or more separate physical buses, point to point connections, or both connected by appropriate bridges, adapters, or controllers. The interconnect 415, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 405 is/are the central processing unit (CPU) of the computer 400 and, thus, control the overall operation of the computer 400. In certain embodiments, the processor(s) 405 accomplish this by executing software or firmware stored in memory 410. The processor(s) 405 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 410 is or includes the main memory of the computer 400. The memory 410 represents any form of random access memory (RAM), read-only memory (ROM), flash memory, or the like, or a combination of such devices. In use, the memory 410 may contain a code. In one embodiment, the code includes a general programming module configured to recognize the general-purpose program received via the computer bus interface, and prepare the general-purpose program for execution at the processor. In another embodiment, the general programming module may be implemented using hardware circuitry such as ASICs, PLDs, or field-programmable gate arrays (FPGAs).

Also connected to the processor(s) 405 through the interconnect 415 are a network adapter 430, a storage device(s) 420 and I/O device(s) 425. The network adapter 430 provides the computer 400 with the ability to communicate with remote devices, over a network and may be, for example, an Ethernet adapter or Fibre Channel adapter. The network adapter 430 may also provide the computer 400 with the ability to communicate with other computers within the cluster. In some embodiments, the computer 400 may use more than one network adapter to deal with the communications within and outside of the cluster separately.

The I/O device(s) 425 can include, for example, a keyboard, a mouse or other pointing device, disk drives, printers, a scanner, and other input and/or output devices, including a display device. The display device can include, for example, a cathode ray tube (CRT), liquid crystal display (LCD), or some other applicable known or convenient display device.

The code stored in memory 410 can be implemented as software and/or firmware to program the processor(s) 405 to carry out actions described above. In certain embodiments, such software or firmware may be initially provided to the computer 400 by downloading it from a remote system through the computer 400 (e.g., via network adapter 430).

The techniques introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine.

A machine can also be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

A machine-accessible storage medium or a storage device(s) 420 includes, for example, recordable/non-recordable media (e.g., ROM; RAM; magnetic disk storage media; optical storage media; flash memory devices; etc.), etc., or any combination thereof. The storage medium typically may be non-transitory or include a non-transitory device. In this context, a non-transitory storage medium may include a device that is tangible, meaning that the device has a concrete physical form, although the device may change its physical state. Thus, for example, non-transitory refers to a device remaining tangible despite this change in state

The term “logic”, as used herein, can include, for example, programmable circuitry programmed with specific software and/or firmware, special-purpose hardwired circuitry, or a combination thereof.

I/We claim:

1. A method for live loading of a toolbar, comprising:
downloading, by a processor, a plain text toolbar script when a browser is launched, wherein the plain text toolbar script is associated with a toolbar installed on the browser;
loading, by the processor, the plain text toolbar script to an instance of the browser; and
executing, by the processor, the plain text toolbar script as code within the instance of the browser.

2. The method of claim 1, wherein the downloading is from a toolbar server.

3. The method of claim 2, further comprising:
prior to the downloading, determining that the plain text toolbar script is a newer version of the toolbar script installed on the browser.

4. The method of claim 2, wherein the downloading includes:
determining whether a network connection to the toolbar server is available;
when a network connection to the toolbar server is available,
transmitting a request to the toolbar server for a new version of the toolbar script for loading into the instance of the browser.

5. The method of claim 4, further comprising:
when a network connection to the toolbar server is not available,
loading and executing the toolbar script installed on the browser.

6. The method of claim 1, wherein the plain text toolbar script is written in JavaScript.

7. The method of claim 1, further comprising:
verifying the authenticity of the plain text toolbar script based on a public encryption key, wherein the plain text toolbar script is encrypted using a private key.

8. The method of claim 4, wherein the request to the toolbar server includes an identifier for the toolbar and a version number.

9. A system for live loading of a toolbar, comprising:
a toolbar start up module including processor-executable instructions to:
download a plain text toolbar script at the start of each browser session, wherein the plain text toolbar script is associated with a toolbar installed on the browser; and
load the plain text toolbar script to an instance of the browser.

10. The system of claim 9, further comprising:
a toolbar execution module including processor-executable instructions to:
execute the plain text toolbar script as code within the instance of the browser.

11. A non-transitory computer readable medium storing processor-executable instructions to:
download a plain text toolbar script when a browser is launched, wherein the plain text toolbar script is associated with a toolbar installed on the browser;
load the plain text toolbar script to an instance of the browser; and
execute the plain text toolbar script as code within the instance of the browser.

12. A method for supporting live loading of a toolbar component, comprising:
providing, via an intermediary server, a first toolbar component that generates an indication when a browser session is launched on a client device;
receiving from the client device, an indication of a browser session generated by the first toolbar component; and
providing to the client device, a second toolbar component, wherein the second toolbar component is loaded by the browser for execution.

13. The method of claim 12, wherein the indication is a HyperText Transfer Protocol Secure (HTTPS) request generated by the first toolbar component.

14. The method of claim 12, wherein a version of the second toolbar component is present on the client device when the second toolbar component provided to the client device is loaded by the browser for execution.

15. The method of claim 12, wherein the first and second toolbar components are script files written in a client-side scripting language.

16. The method of claim 15, wherein the first toolbar component is provided as an executable script and the second toolbar component is provided as plain text.

17. The method of claim 12, wherein the indication includes information relating to a version of the second toolbar component present on the client device.

18. The method of claim 17, further comprising:
providing an update package including the second toolbar component based on the version of the second toolbar component present on the client device and at least one update rule.

19. The method of claim 12, further comprising:
signing the second toolbar component using a private key encryption.

20. A non-transitory computer readable medium storing processor-executable instructions to:
provide a first toolbar component that generates an indication when a browser session is launched on a client device;
receive from the client device, an indication of a browser session generated by the first toolbar component; and
provide to the client device, a second toolbar component, wherein the second toolbar component is loaded by the browser for execution.
